(19) United States
(12) Patent Application Publication
(10) Pub. No.: US 2015/0019359 A1
(43) Pub. Date: Jan. 15, 2015

(54) SYSTEM AND METHOD FOR DISCOVERY MOMENT MONETIZATION OF MEDIA

(71) Applicant: REMI SWIERCZEK, MENTOR, OH (US)

(72) Inventor: REMI SWIERCZEK, MENTOR, OH (US)

(21) Appl. No.: 13/942,221

(22) Filed: Jul. 15, 2013

(51) Int. Cl. G06Q 20/12

(52) U.S. Cl. CPC G06Q 20/1235
USPC 705/26.1

(57) ABSTRACT

Systems and methods for signing a media with a portion of data to define parameters for use of the media. A signed media can be created to include a portion of data that defines one or more parameters, wherein the one or more parameters can define an allowed access for the media, a payment amount for access to the media, a payment distribution for the payment amount between one or more entities, among others. The signed media can track the manner in which media is distributed in an online environment and affords incentive to outlets or sources to regulate authenticity of such media.

### BACKGROUND

1. Technical Field

Embodiments of the subject matter disclosed herein relate to media distribution and verification.

2. Discussion of Art

Conventionally, media, such as video or audio, were physically packaged and sold in brick and mortar stores. With the advent of the Internet, increased storage capacity for data, decreased costs for data storage, among others, the conventional distribution chain for media has drastically changed. For instance, media can be purchased in electronic format via the Internet. In a particular example, a device can be used to purchase an entire album in electronic format and store such electronic format album in the device.

In addition to purchasing media electronically, distribution of media has become possible with streaming, peer-to-peer networks, websites, cloud-based servers, among others. With the various sources of distribution (e.g., physical stores, websites, servers, cloud-based servers, streaming sites, radio, satellite radio, television, cable television, satellite television, the Internet, and the like) for media, management and tracking of the media is needed.

### BRIEF DESCRIPTION

In an embodiment, the subject innovation is to provide tools and incentive to media and particularly music broadcasters to participate in monetization of media. Another purpose is to allow entities like radio, TV, large chains of restaurants, or stores to utilize the disclosed systems and methods to promote new art and share in profits.

Tracking systems and methods disclosed by this invention will allow for fair funds distribution to all parties involved in monetization of media. In each particular case of media acquisition, actual contributors will be compensated. Introduction of the subject systems and methods will allow to monetize music at the discovery moment (e.g., a moment in time when a user discovers, hears, sees, media). All entities broadcasting media will drastically improve content to allow for maximum participation in this new income source. Implementation of this invention can allow a distributor of media to make money rather than pay money for use of the media. This application will cover also methods of tracking based on number (e.g., a phone number, a cellular phone number, a random number, a pre-defined number, a dynamically number, among others) assigned to particular broadcast of media, or application (e.g., smartphone application, cellular service based application, Wi-Fi service based application, computer application, among others).

In an embodiment, a system is provided that includes a first component that is configured to incorporate a portion of data to a media to create a signed media, wherein the portion of data includes a parameter. The system can further include a second component that is configured to provide a device a restricted access to the signed media, wherein the restricted access of the signed media to the device is defined by the parameter. The device can communicate a request to at least the first component or the second component for an unrestricted access to the signed media.

In an embodiment, a method is provided that includes at least the following steps: receiving a media from an original author or a representative of the original author; authenticating an ownership of the media; defining a parameter for the media that defines at least a payment amount for an ownership or a payment distribution; associating the parameter with the media to create a signed media; and communicating the signed media. In another embodiment, a method is provided that includes at least the following steps: receiving the signed media; distributing the signed media via the Internet, a network, or a radio station; receiving a request from a device to purchase the signed media; evaluating the parameter for the signed media to identify the payment amount; receiving the payment amount from the device; and authorizing the device to download an electronic copy of the signed media based on the receipt of the payment amount from the device.

In an embodiment, a system is provided that includes at least one of the following: means for incorporating a portion of data to a media to create a signed media, wherein the portion of data includes a payment amount and a distribution of the payment amount; a media source that is configured to distribute the signed media via at least one of radio waves or the Internet; means for capturing a portion of the signed media in at least one of an audio form or a picture form from the media source; means for identifying the payment amount for the signed media based on the captured portion of the signed media; means for receiving the payment amount; and means for disturbing the payment amount for the signed media based on the distribution.

### BRIEF DESCRIPTION OF THE DRAWINGS

Reference is made to the accompanying drawings in which particular embodiments and further benefits of the invention are illustrated as described in more detail in the description below, in which:

FIG. 1 is an illustration of a system for creating a signed media that indicates a source that distributed the signed media upon purchase;

FIG. 2 is an illustration of a system for distributing signed media to more than one source for distribution and potential purchase by one or more devices;

FIG. 3 is an illustration of a system for creating a signed media that indicates a source that distributed the signed media upon purchase;

FIG. 4 is an illustration of a system for generating signed media for tracking a distribution of signed media upon purchase;

FIG. 5 is an illustration of a system for creating signed media with an encoding of data in a frequency;

FIG. 6 illustrates a flow chart of a method for generating a signed media that includes parameters that define use thereof;

FIG. 7 illustrates a flow chart of a method for distributing a payment amount for media based upon a portion of data included in signed media; and

FIG. 8 illustrates a flow chart of a method for utilizing a frequency to encode a parameter for the media.

### DETAILED DESCRIPTION

Embodiments of the present invention relate to methods and systems for signing a media with a portion of data to define parameters for use of the media. A signed media can be created to include a portion of data that defines one or more parameters, wherein the one or more parameters can define an allowed access for the media, a payment amount for access to the media, a payment distribution for the payment amount between one or more entities, among others. The signed media can track the manner in which media is distributed in an online environment and affords incentive to outlets or sources (discussed below) to regulate authenticity of such media.

For example, conventional techniques require a copyright owner to self-regulate and notify third-parties of illegal use of media (e.g., filing a copyright infringement complaint to a website/host). However, signed media as provided herein includes parameters that pay monetary compensation to a source of distribution when the media is purchased and/or accessed. In comparison, conventional media does not include any defined cost or money to be paid to a source of distribution. Thus, a source of distribution would have a monetary gain to remove any media that is not signed media, wherein this monetary gain is incentive for regulation from sources that distribute media in which this regulation is in addition to the already provided self-regulation.

With reference to the drawings, like reference numerals designate identical or corresponding parts throughout the several views. However, the inclusion of like elements in different views does not mean a given embodiment necessarily includes such elements or that all embodiments of the invention include such elements.

The term “media” as used herein can be defined as a portion of video, a portion of audio, a portion of audio in an electronic format, a portion of video in an electronic format, a portion of audio and a portion of video in an electronic format, a digital format for portion of video, a digital format for a portion of an image, a digital format for a portion of audio, or a combination thereof.

The term “signed media” as used herein can be defined as a portion of media that has incorporated a portion of data that includes a parameter defining at least one of a payment amount, an access definition, a payment distribution, or a permitted source for distributing the media. It is to be appreciated that the addition of the portion of data to the media is not considered to generate an original work or a derivative work of the media. Thus, the copyright holder of the media is also the copyright holder of the signed media.

The term “source” as used herein can be defined as a component that is configured to distribute electronic data, and in particular, electronic media.

The term “device” as used herein can be defined as a component that is configured to communicate (e.g., receive, transmit, or combination thereof) data packets for communication on at least one of the Internet or a network.

The term “owner” or “ownership” as used herein can be defined as a copyright holder of the media in accordance with U.S. Copyright laws or the foreign equivalent for copyright protection outside the U.S.

The term “original author” as used herein can be defined as an original author as used with copyright laws in the United States of America or the foreign equivalent for copyright protection outside the U.S.

The term “representative” as used herein can be defined as an attorney, a legal representative, or an agent.

The term “component” as used herein can be defined as a portion of hardware, a portion of software, or a combination thereof. A portion of hardware can include at least a processor and a portion of memory, wherein the memory includes an instruction to execute. Additionally, “component” as used herein includes, but is not limited to: any programmed, programmable, or other electronic device or portion thereof that can store, retrieve, and/or process data; one or more computer readable and/or executable instructions, stored on non-transitory computer-readable medium/media, that cause an electronic device to perform one or more functions, actions, and/or behave in a desired manner as specified in the instructions; or combinations thereof

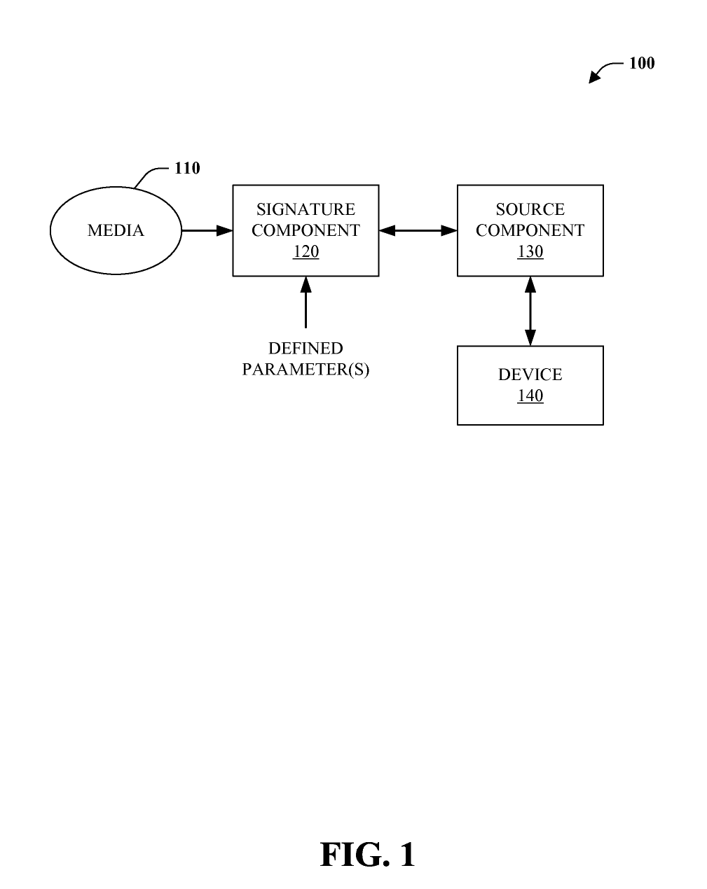

FIG. 1 illustrates a system 100 for creating a signed media that indicates a source that distributed the signed media upon purchase. The system 100 can include a signature component 120 that is configured to incorporate a portion of data into a media 110, wherein the portion of data includes one or more parameter(s) related to the media 110. The signature component 110 creates a signed media with the incorporation of the portion of data into the media. The defined parameter(s) can be related to the media 110 and in particular the use of the signed media. By way of example and not limitation, the one or more defined parameter(s) can be a payment amount for authorization of receiving an electronic copy of the signed media, a payment distribution that allocates the payment amount to one or more entities (discussed in more detail below), a type of allowed use of the signed media, a list of one or more sources that are authorized to distribute the signed media, and/or any combination thereof.

Within the system 100, the signed media can be distributed (e.g., communicated, transmitted, sent, etc.) to a source component 130 that is configured to host the signed media to allow access or distribution thereof. The source component 130 can be, but is not limited to being, a website, a server, a social network, a cloud-based network, a hard drive, a computer, a peer-to-peer network, or a combination thereof. The source component 130 can store and host one or more electronic versions of the signed media for access to the device 140. The device 140 can communicate with the source component 130 to view and/or access the signed media based upon the parameter(s) defined with the portion of data incorporated therein. In an embodiment, a signed media can include one or more parameter(s) that define a preview period. In another embodiment, a signed media can include one or more parameters that define an unlimited amount of use (e.g., streaming use of the signed media).

A request for a purchase of an electronic version of the signed media can be received from the device 140. Based upon one or more parameter(s) of the signed media, a payment amount is communicated to the user by at least one of the signature component 120, the source component 130, and/or the device 140. In another embodiment, a request for access to the signed media can be received from the device 140, wherein the signed media is evaluated to identify a parameter related to the use definition(s) via the one or more parameter(s). For example, the device 140 can send a request and the signature component 120 can evaluate the signed media to identify a payment amount (or a type of allowed use) based on the one or more parameter(s) for the signed media. In another example, the device 140 can indicate a request in which the device 140 dynamically communicates the portion of data to retrieve a payment amount (or a type of allowed use). In another example, the device can send a request and the source component 120 can evaluate the signed media to identify a payment amount (or a type of allowed use). It is to be appreciated that the detection of the portion of data and identification of the one or more parameters associated thereto can be performed by at least one of the signature component 120, the source component 130, the device 140, and/or a combination thereof.

In an embodiment, the device 140 can be, but is not limited to being, a computer, a desktop machine, a tablet, a portable device, a portable digital assistant (PDA), a smartphone, a laptop, a desktop computer, a computing device, a porting gaming device, a game console, a device that can communicate data packets via the Internet, and the like. In addition, it is to be appreciated that the signature component 120 can be a stand-alone component (as depicted), incorporated into the source component 130, incorporated into the device 140, or a combination thereof.

It is to be appreciated that the media can be at least one of a portion of audio in an electronic format, a portion of an image in electronic format, or a portion of video in an electronic format. It is to be appreciated that the portion of data incorporated into the media 110 to create a signed media (not shown) can be, but is not limited to being, a number, a code, a letter, a Quick Response (QR) code, an image, a portion of a graphic, a combination of a number and a letter, a human interaction proof (HIP), a frequency encoded portion of data, data encoded with frequency in a portion of audio of the media, an audio watermark, among others. In an embodiment, the portion of data can be referred to as a license plate that identifies the media 110 as well as definitions related to purchase, royalties, and/or restrictions of use.

For example, a media can be incorporated with a portion of data (e.g., numbers, letters, symbols, a combination thereof, and the like), wherein the portion of data is referenced in a data store or table (not shown) to identify one or more parameter(s). The portion of data incorporated into the media 110 creates a signed media in which the signed media is used to identify or detect parameter(s). In an embodiment, the parameter(s) can be used to define a payment amount for purchase or initial stream leading to ownership of an electronic version of the signed media. In an embodiment, the initial stream can include an additional paid stream leading to ownership of an electronic version of the signed media. In another embodiment, the parameter(s) can be used to defined a payment distribution of the payment amount.

In another embodiment, the use or access of the signed media is defined by the one or more parameter(s). By way of example and not limitation, a parameter can define at least one of a restricted access to the signed media or an unrestricted access to the signed media. For instance in a restricted access of signed media, a parameter(s) can define a number of views for the signed media before a payment amount is required for use of the signed media. Thus, a preview duration (e.g., restricted use) of the signed media can be defined with the one or more parameter(s). This preview duration (e.g., restricted use) can be a number of views (e.g., plays, listens, executions, uses, and the like) or an amount of time the signed media can be played before access is restricted. In an embodiment, the restricted access is at least one of a pre-defined amount of time for a preview of the signed media or a pre-defined number of uses for the signed media. In an embodiment, the unrestricted access is at least one of a full duration of time for use of the signed media, an unlimited number of uses for the signed media, or a right to store an electronic version of the signed media on at least the device.

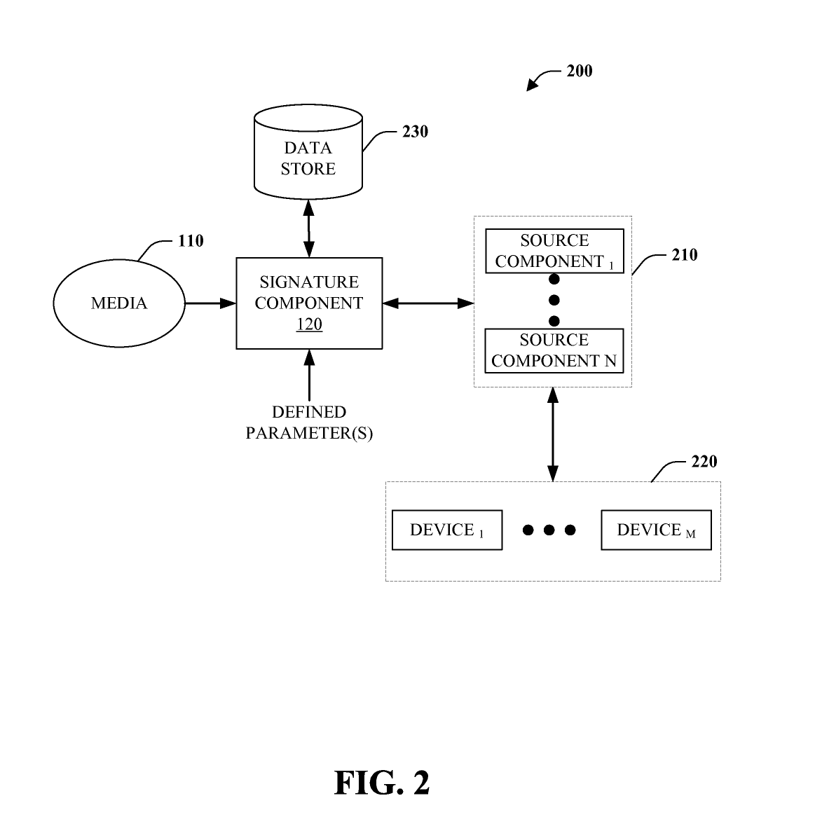

FIG. 2 illustrates a system 200 for distributing signed media to more than one source for distribution and potential purchase by one or more device. The system 200 can include one or more sources 210 in which each of the one or more sources 210 can be substantially similar to the source component 130. By way of example and not limitation, there can be any suitable number of sources 210 such as source₁ to source_{N}, where N is a positive integer. Additionally, the system 200 can include one or more devices 220 in which each of the one or more sources 220 can be substantially similar to the device 140. By way of example and not limitation, there can be any suitable number of devices 220 such as device₁ to device_{M}, where M is a positive integer. It is to be appreciated that any suitable subset of the devices 220 can be owned or utilized by any suitable number of users. For instance, a first user can own and utilize a first device and a second device to purchase an electronic copy of the signed media, while a second user can use a third device to purchase an electronic copy of the signed media.

In an embodiment, the signature component 120, the one or more sources 210, the one or more devices 220, and/or a combination thereof stores information related to the systems 100, 200, 300, 400, and/or 500 with a data store 230. The data store 230 can include information such as, but not limited to, defined parameter(s), a portion of data, the media 110, signed media, source list (e.g., verified source, restricted source, authorized source, etc.), copyright data related to the media 110, ownership data for the media 110, source of the media 110 (e.g., username, name, address, billing address, and the like), fund data (e.g., account information, bank account number, and the like), analytic data (discussed below), among others, and/or a suitable combination thereof.

It is to be appreciated that the data store 230 can be, for example, either volatile memory or nonvolatile memory, or can include both volatile and nonvolatile memory. The data store 230 of the subject systems and methods is intended to comprise, without being limited to, these and other suitable types of memory. In addition, it is to be appreciated that the data store 230 can be a server, a database, a hard drive, a flash drive, a solid state drive, an external hard drive, a portable hard drive, a cloud-based storage, a distributed storage architecture, a network storage device, and the like.

In an embodiment, a device can request information from the portion of data incorporated into the signed media. In one example, the request can be related to a desire to purchase an electronic copy of the signed media. In another example, the request can be related to a desire to play or use the signed media, wherein the type of use allotted is defined by the one or more parameters of the signed media.

In an example, a user can view the signed media and provide an input, wherein the input corresponds to the signed media and initiates a purchase request or type of use request. The input can be, but is not limited to, a keystroke, a code, a touchpad entry, a mouse input, a email reply, a touch screen input, a voice command, a biometric input, a text message, an email, a Short Message Service (SMS), a motion input, an eye movement, and/or a combination thereof.

In another example, a user can hear the signed media and provide an input, wherein the input corresponds to the signed media and initiates a purchase request or a type of use request. The input can be an execution of a microphone (e.g., record a portion of audio), a camera command (e.g., capture a portion of display from audio display), among others. For instance, the signed media can have a display that is shown on a radio, wherein the device can capture the display with the date and/or time to identify the signed media and/or the one or more parameter(s).

In another example, the signed media can be from a video web sharing service, wherein a type of use is defined in the one or more parameter(s) of the signed media. The signed media can include one or more parameters that define the type of use based on a number of views. For instance, a number of views can be set and before that number is reached, a first type of use is provided and after the number is reached a second type of use is provided. It is to be appreciated that more than one number can be set for any number of types of use. For instance, the first ten (10) views of the signed media can have the type of use defined as free, eleven (11) views and more of the signed media can have a type of use defined as a first cost, and so on and so forth. In other words, a tiered system for pricing and type of use can be implemented with the signed media.

In another example, a video can be viewed for a portion of a full length of the video, wherein a user can request a purchase or request for a change in type of use for such video (e.g., signed media). In another example, the counter (e.g., number of views or uses of the signed media) of which the device viewed can correspond to a payment amount as defined in the one or more parameter(s). For example, a user that finds a signed media earlier can get a lower price. In still another embodiment, an advertisement (e.g., a type of advertisement, a price amount for ad space, a size of an advertisement, a target device for the advertisement, among others) for the one or more sources 210 can be based on a request (e.g., purchase request, request for an access or definition of a type of use, etc.) from the one or more devices 220.

In an example, a user can be a passenger in a car and hear a song (e.g., signed media) on a radio station (e.g., the source component). The user may want to send a request to get more access to the song or to purchase an electronic copy of the song. The user can use a smartphone (e.g., the device) to listen to the song to detect the signed media, wherein a parameter associated with the song can define a type of use and/or a payment amount. The user can further use the smartphone to complete a transfer of the payment amount. Moreover, one or more parameter(s) can define how the payment amount is distributed (e.g., a payment distribution) to at least one of the radio station, the owner of the copyright, or an entity that created the signed media. In an embodiment, payments can be distributed on periodical basis by the broadcaster (e.g., source component, central media bank, among others) to proper recipients for the number of songs processed in given a billing period.

In another example, a user can be on a computer (e.g., the device) and see a video (e.g., the signed media) on a website (e.g., the source component) that he or she has interest in viewing more or wanting to purchase an electronic copy of the video. The user can send a request, wherein the signed media (here the video) can be evaluated to identify one or more parameter(s) for the media. Based on the parameter(s), the user can continue to purchase or view the video based on the definitions included within the signed media. Based on a purchase request, the user can complete a transfer of payment for the video, wherein the payment amount can be distributed in accordance with the defined payment distribution of the signed media.

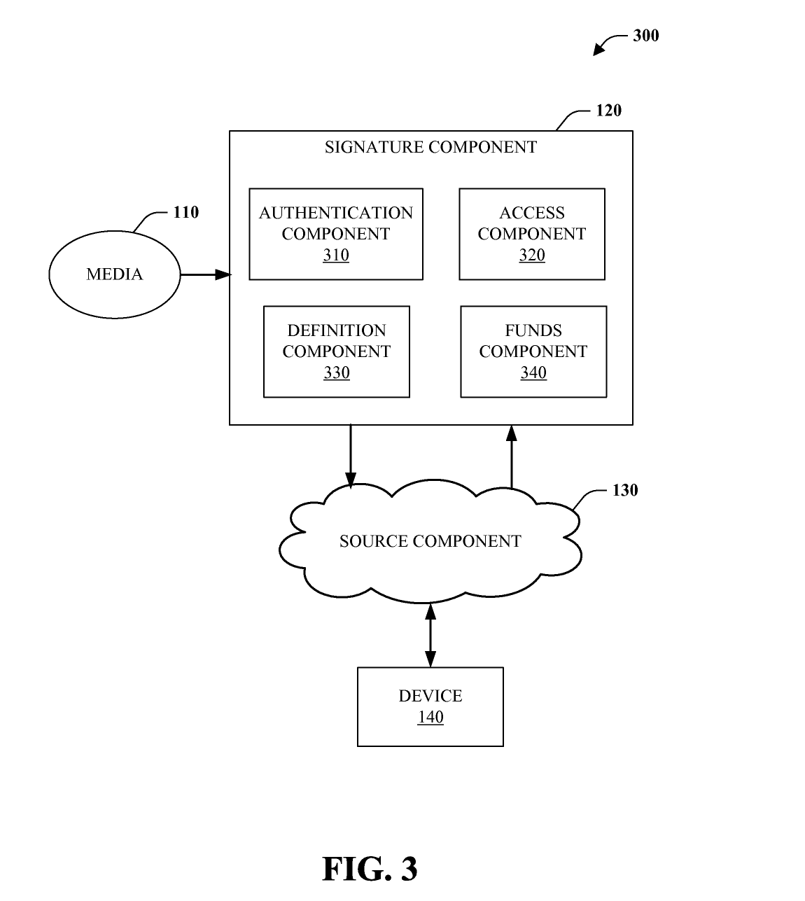

FIG. 3 illustrates a system 300 for creating a signed media that indicates a source that distributed the signed media upon purchase. The system 300 can include the media 110 that can be embedded with a portion of data, incorporated with a portion of data, appended with a portion of data, and the like to create a signed media. In particular, the signature component 120 can be configured to create the signed media, wherein the signed media includes the portion of data that defines one or more parameter(s). The one or more parameter(s) can be employed to manage a use of the signed media. The signed media can further be distributed or hosted for access to the device 140 via the source component 130. It is to be appreciated that the source component 130 is depicted in FIG. 3 as a cloud-based component, yet any suitable component, server, network, or distributed environment can be utilized for the source component 130.

By way of example and not limitation, the one or more parameter(s) can manage at least one of a type of use (e.g., number of views allotted, duration of time for use, restriction of audio of the signed media, restriction of video of the signed media, a type of restriction, a type of unlimited use, and the like), a payment amount (e.g., price to purchase an electronic copy, a pay-per-use price, a flat-fee, an unlimited use price, a limited use price, a price based on a source component that distributes, a group price for two or more signed media, among others), a list of valid distribution sources (e.g., source that can distribute the signed media, source that is unauthorized to distribute the signed media), a combination thereof, among others.

The signature component 120 can include an authentication component 310 that is configured to verify data received. In particular, the authentication component 310 can be configured to verify the media 110 in terms of a sender (e.g., source of upload, source of transmission, source of communication, and the like) or an ownership of the media, wherein the ownership is related to a copyright of the media 110 and rights for distribution. In an embodiment, the authentication component 310 can leverage a third-party, a website, a user verification, among others to validate the owner of the media 110. For instance, the receipt of the media 110 can also require a registration of the media 110 with the U.S. Copyright Office or a foreign country equivalent for copyright protection. Another verification can be conventional Internet protective techniques such as, but not limited to, username, password(s), Human Interactive Proofs (HIPs), email authentication, text message response, security code transmission and return request, among others. The authentication component 310 can further display information regarding a penalty or legal consequence for communicating or sending in media 110 that is not owned by the sender. It is to be appreciated that the authentication component 310 can be incorporated into the signature component 120 (as depicted), a stand-alone component, incorporated into the source component 130, incorporated into the device 140, and/or a combination thereof.

The system 300 and the signature component 120 can further include an access component 320 that is configured to manage a transfer of an electronic version or copy of the signed media based on a request. The access component 320 can enable a transfer of the signed media by at least one of a streaming of data of the signed media (e.g., streamed and viewed or used in real time upon receipt of the stream of data) or a transfer of an electronic format of the signed media (e.g., stored and hosted by the device 140). The access component 120 can be configured to receive a request from the device 140 for a particular signed media and identify one or more parameter(s) for the signed media that define at least one of a type of use for the signed media or a payment amount for the signed media. It is to be appreciated that the one or more parameter(s) can be identified for the signed media in any suitable component of the system 300 such as, but not limited to, the device 140, the source component 130, the signature component 120, and/or any suitable combination thereof. For instance, the request can include information related to which signed media and then can be handled by any of the components in the system 300 to identify the one or more parameter(s). It is to be appreciated that the access component 320 can be incorporated into the signature component 120 (as depicted), a stand-alone component, incorporated into the source component 130, incorporated into the device 140, and/or a combination thereof.

The signature component 120 can further include a definition component 330 that is configured to manage a portion of data included with the media 110 to create a signed media. The definition component 330 can be configured to manage (e.g., create, define, update, edit, etc.) a portion of data that is associated with the media 110 to create the signed media. For instance, an owner of the copyright for the signed media or an agent for the owner of the copyright of the signed media can edit one or more parameter(s) defined by the portion of data in the signed media.

By way of example, the one or more parameter(s) can be adjusted based on a number of uses, a number of sales, an amount of traffic on one or more source components, a duration of time, among others. Further, it is to be appreciated that the one or more parameter(s) can be adjusted automatically and/or dynamically based on triggers or other criteria set. For instance, a payment amount can be set at a first price and upon a particular date (e.g., a trigger), a second price can be implemented dynamically and automatically. By way of example and not limitation, the trigger can be a date, a time, an amount of traffic, a number of sales, a number of advertisements, a number of requests (e.g., request for use, request for purchase, among others), and the like. It is to be appreciated that the definition component 330 can be incorporated into the signature component 120 (as depicted), a stand-alone component, incorporated into the source component 130, incorporated into the device 140, and/or a combination thereof.

The signature component 120 can further include a funds component that is configured to perform an electronic transfer of funds from at least the device 140 for at least one of a use of the signed media or an electronic copy of the signed media. The funds component 340 can collect data for a user to complete and perform a purchase of the signed media in an online environment (e.g., network, server, the Internet, a peer-to-peer network, etc.). The data collected can be, but is not limited to, bank account number, account number, savings account information, name, address, credit card information, driver license information, online account information, username, password, security question data, among others. It is to be appreciated that the funds component 340 can be incorporated into the signature component 120 (as depicted), a stand-alone component, incorporated into the source component 130, incorporated into the device 140, and/or a combination thereof

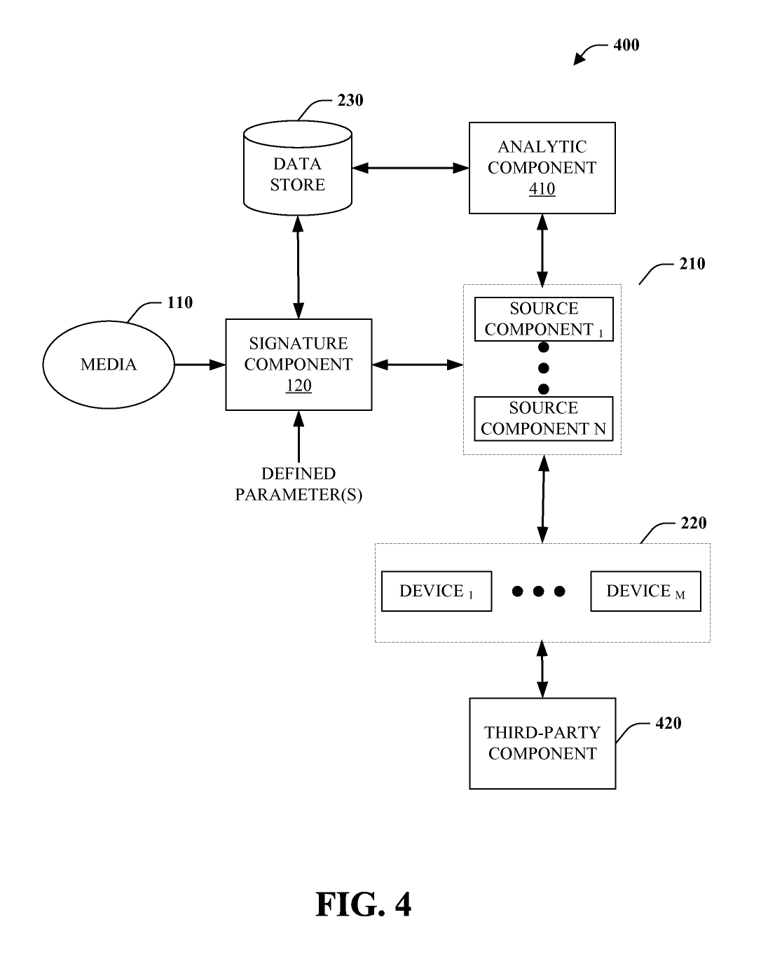

FIG. 4 illustrates a system 400 for generating signed media for tracking the distribution of signed media upon purchase. The system 400 can include an analytics component 410 that can be configured to update parameter(s) for a signed media, monitor data, track data, collect data, and/or analyze data, wherein the data is related to the system 100, the system 200, the system 300, the system 400, and/or the system 500 (discussed below). The analytics component 410 can be accessed by the source component 130, an owner of a copyright for the media, an agent of the copyright owner, a legal representative of the copyright owner, an entity contracted to access such data, among others. The system 400 illustrates one or more sources 210 utilizing the analytics component 410. It is to be appreciated that the business analytics component 410 can be a stand-alone device (as depicted), incorporated into the source component 120, incorporated into one or more source components 210, or a suitable combination thereof.

In particular, the analytics component 410 can allow customization of one or more parameter(s) associated with one or more signed media. In another embodiment, specific data for each signed media can be identified and tracked in order to provide insight on a particular signed media use, sale, distribution, and the like. In an embodiment, the analytics component 410 can be customized with functions, formulas, equations, and the like to calculate figures or quantities. For example, a set of data can be collected for a signed media in which an efficiency can be calculated on a distribution payment parameter and/or a payment amount for a specific source component. For instance, the analytics component 410 can determine a payment amount for a particular source component based on sales data (e.g., historic data) tracked from previous sales of the signed media. In another embodiment, the analytics component 410 can determine a payment distribution based on historic data aggregated from the signed media such as, but not limited to, sales numbers, sales numbers from each source component, among others. In still another embodiment, the analytics component can determine a use for the signed media based on historic data aggregated from the signed media such as, but not limited to, duration of use of the signed media and purchase request, number of purchases from a source component and use permitted, among others.

The analytics component 410 can provide at least one of the following: number of sales for the signed media; a number of sales from each source component, a payment amount for the signed media, a payment amount for the signed media for the source component that distributes; a payment distribution for the signed media; historic information related to one or more parameter(s) for the signed media; data related to source component(s) 210; data related to one or more device(s) 220; type of the media; predictive data (e.g., prognostic data related to prediction of change in payment distribution, change in source component(s), change in payment amount, among others); among others.

The system 400 can further include a third-party component 420 that is configured to detect one or more parameter(s) incorporated into a signed media. In an embodiment, the third-party component 420 can detect the one or more parameter(s) in the signed media based on decoding an audio watermark. In another embodiment, the third-party component 420 can detect the one or more parameter(s) in the signed media based on detection of a portion of audio of the media, a portion of video of the media, a portion of an image of the media, and the like. The third-party component 420 can be detect the portion of data incorporated into the media to create signed media, wherein the portion of data is at least one of a number, a code, a letter, a Quick Response (QR) code, an image, a portion of a graphic, a combination of a number and a letter, a human interaction proof (HIP), a frequency encoded portion of data, data encoded with frequency in a portion of audio of the media, an audio watermark, among others.

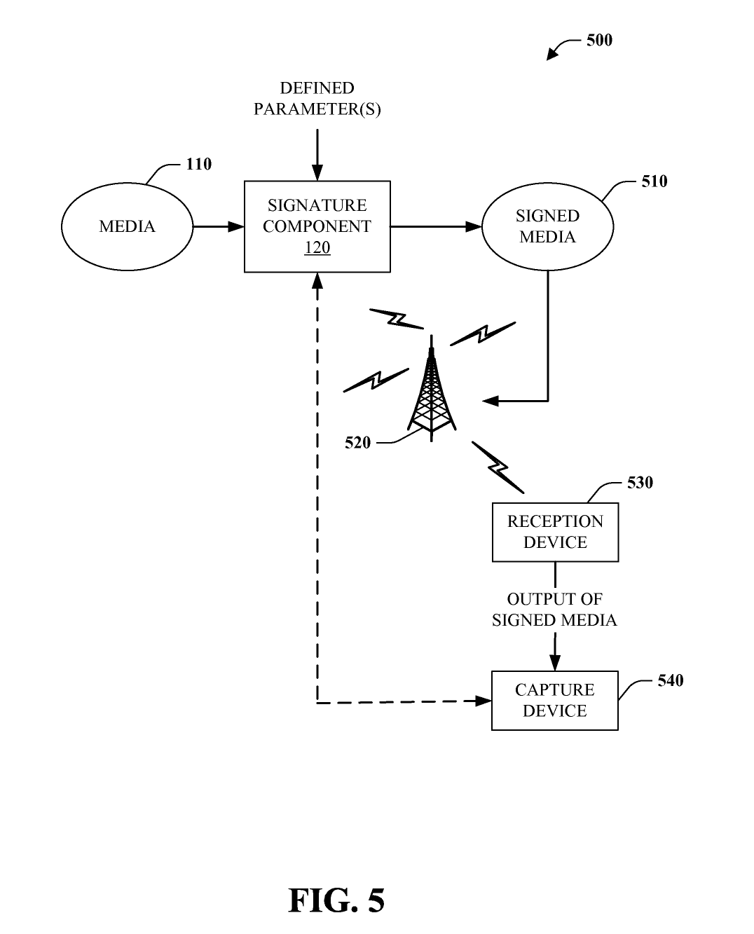

FIG. 5 illustrates a system 500 for creating signed media 510 with an encoding of data in a frequency. The system 500 include the media 110 that is appended with a portion of data to generate a signed media 510, wherein the portion of data includes one or more defined parameter(s). As discussed above, the defined parameter(s) can relate to at least one of the following: a payment amount for a purchase of the signed media 510; a payment distribution of the payment amount for the signed media 510; a definition of use for the signed media 510 (e.g., a number of free uses before a payment amount is required for use, etc.); a list of approved sources for distribution or access to the signed media 510 (e.g., approved source component, disapproved source component, website that has a restricted use of the signed media 510 based on copyright violation, and the like); among others. In a particular instance, the system 500 illustrates a communication of signed media 510 and a reception thereof, wherein the reception is indirect from a device requesting a purchase of the signed media 510. In other words, the device requesting the purchase is not the device using the signed media 510 directly but rather is capturing a portion of the signed media 510 indirectly.

The signed media 501 can be transmitted from a source 520 via a wired connection or a wireless connection, wherein the source 520 is at least one of a radio station, a TV station, a satellite, a satellite radio station, a cable TV provider, the Internet, and the like. A reception device 530 can be configured to receive the signed media and use the signed media (e.g., play, view, hear, display, etc.). The reception device 530 can include an output component (not shown) that allows output of the signed media, wherein the output can be a portion of audio of the signed media (e.g., via a speaker), a portion of video of the signed media (e.g., via a display), a portion of an image of the signed media (e.g., via a display), and the like.

A capture device 540 is further included in the system 500 that is configured to capture a portion of the output from the reception device 530. The capturing of the portion of the output can be via at least one of a camera of the capture device 540, a microphone of the capture device 540, or a video camera of the capture device 540. Upon capturing of the portion of the output, the capture device can identify the signed media based on evaluation of the portion of the output (e.g., identification of audio signature, identification of an encoded frequency, identification of video frame, identification of a portion of an image, portion of data, assigned phone number, random number, cellular phone number, pre-defined number, dynamically generated number, at least one digit, at least one letter, a text message, a random text message that includes at least one of a digit or a letter, QR code, website, and the like) and further identify the portion of data incorporated into the media the create the signed media. Once the signed media is identified and one or more parameter(s) are ascertained, the capture device 540 can request a purchase of the signed media. It is to be appreciated that FIG. 5 illustrates the request being sent to the signature component 120 but the request can be communicated to at least one of the signature component 120 or the source 520.

In the embodiment in FIG. 5, a payment distribution can be a parameter defined in the portion of data incorporated with the media. The payment distribution can include a distribution of a payment amount for the signed media that includes an owner of a copyright for the signed media, the source 520, and an owner of the reception device 530. This allows for incentive for the source 520 to distribute the signed media but also for an owner of a reception device to share the signed media with other users.

The following describes embodiments and features that are included within the subject disclosure and innovation. In an embodiment, the parameter defines a payment amount that is to be received from the device to provide the device with the unrestricted access to the signed media. In an embodiment, the parameter defines a payment distribution for the payment amount between at least one of an owner of the media or a host of the second component. In an embodiment, the parameter defines a payment distribution for the payment amount between at least one of an owner of the media or a host of the first component. In an embodiment, the restricted access is at least one of a pre-defined amount of time for a preview of the signed media or a pre-defined number of uses for the signed media. In an embodiment, the media is at least one of a portion of audio in an electronic format or a portion of video in an electronic format. In an embodiment, the unrestricted access is at least one of a full duration of time for use of the signed media, an unlimited number of uses for the signed media, or a right to store an electronic version of the signed media on at least the device.

In an embodiment, the second component is at least one of a website, a server, a social network, a cloud-based network, a hard drive, a computer, or a peer-to-peer network. In an embodiment, the system can include a third component that is configured to authorize an ownership of the media. In an embodiment, the system can include a fourth component that is configured to receive a request via at least one of the device or the second component, wherein the request is an electronic transmission from the device in a format. In an embodiment, the format is at least one of a transmission of data packets via the Internet, a short message service (SMS) message, a text message, an email, a capture of a Quick Response (QR) code, an input from a keyboard, or an input from the device. In an embodiment, the system can include a fifth component that is configured to dynamically adjust the parameter based on at least one of a number of restricted access, a number of unrestricted access, or a number of the requests. In an embodiment, the second component is at least one of a video sharing website, an audio sharing website, a text sharing website, a streaming video sharing website, or a streaming audio sharing website.

In an embodiment, a computer-readable medium can be provided that stores data related to at least one of the following: the media; the signed media; a portion of data incorporated into a media to create a signed media; one or more parameter(s); a parameter that defines at least one of a type of use, a payment amount, a list of valid distribution sources, and the like; and/or a combination thereof. The computer-readable medium can be utilized by at least one of a component and/or a processor.

It is to be appreciated that “Discovery Moment Monetization” relates to a first time ever opportunity for broadcaster (e.g., radio, store, café, radio station, any distributor that disseminates the media, among others) to participate in monetization of media and endorsement of new musicians. This invention relates to changing an industry related to media such as, music, movies, pictures, among others.

In an embodiment, the subject innovation can include a central clearing house (e.g., system 100, among others) that distributes media. For instance, media (e.g., streams, deliveries, etc.) go from one source. This can be independent whether or not the source is from a deal related to APPLE®, AMAZON®, SPOTIFY®, any other corporation, among others. This central clearing house can count all individual streams for streaming service and convert the media at predefined point to ownership. The systems and embodiments disclosed allow the avoidance of a secondary payment for already owned media. Therefore, people will have more confidence to click (e.g., access, request access, etc.) anything while browsing media on the Internet. For instance, while using SHAZAM®, a user can more freely browse to find media rather than be concerned of the cost for each use of SHAZAM®.

In an embodiment, a distributor such as a radio station (e.g., conventional radio waves, satellite radio, among others) can display a portion of data in addition or in place of the name of the artist and/or song on a receiving device (e.g., smartphone, radio receiver, display screen, etc.). The portion of data can be a phone number or a website, or a QR code. This portion of data can be scrolled, periodically displayed, or displayed upon a button/input. This portion of data can be unique to the media (e.g., that particular song, artist, etc.). The user (e.g., listener) can use the portion of data to get access to the media. For instance, if a phone number, the user can dial the number. If a website, the user can use a device to access the website. If a QR code, the user can scan the code. This initiates a request from the user to have access to the media.

Based on the access, the distributor (here, the radio station) can get a share of a price of the media based on the purchase completed by the access request. In another embodiment, the distributor can split a dollar amount with the owner of the media. For instance, this rewards the distributor for spreading or communicating the media to users who eventually access the media.

In another embodiment, the display on the receiver device (e.g., radio, device, smartphone, etc.) can include a portion of data (e.g., a phone number and a code). Based on a limited amount of data that can display with Radio Data System (RDS), the portion of data can be a short-hand in, for example, the phone number can exclude an area code since the location of the user can be used to determine the area code. This, among other techniques, can utilize the amount of display space and/or RDS.

In another embodiment, a Smart phone application or component can capture a picture of the display of the receiving device which can later be used to access the media. This would allow any distributor (e.g., radio station, etc.) to create custom playlists or groups of media so that monies received (e.g., from access of the media upon user request via the captured picture) can be shared between the distributor and the owner of the media. For instance, this can avoid redundant royalty payments that do not go to directly to the owner of the media.

The above embodiments illustrate a premium price for incoming texts or request for access from users. This can involve cell phone operators, cell phone service providers, Internet service providers, Wi-Fi hot spot owner, among others. Thus, a radio station can split monies between a phone company (e.g., based on phone number called to get access) and with the owner of the media. In another example where the user requests and gains access to the media via a website, the Internet service provider can share monies (e.g., money used to purchase access of the media) with the radio station and the owner of the media.

In an embodiment, the portion of data displayed on the receiving device can be protected via copyright laws (e.g., U.S. Copyright Law, foreign copyright law, etc.). If a user attempts to change the portion of data, it can be seen as an attempt of piracy, copyright law violation, among others.

In another embodiment, retail locations often play media for customers. In such environments, the portion of data can be displayed on device in the retail location and allow a user to access or request access to the media (e.g., based on the portion of data being displayed on the device). In such example, monies can be shared between the source (e.g., radio station playing the media, etc.), the retail location, and the owner of the copyright.

In another embodiment, a user can search for a lyric to media on a search engine via the Internet. In the search results, the media can be accessed based on a displayed link for additional confirmation, message, and/or cost. For instance, if you are listening to a song by an artist, send a text to a number and receive a link to the song for a price billed to your cell phone. In another embodiment, the user can log into a website for a price to access the song.

In another embodiment, YOUTUBE® can include copy protected media that is listed by owners. One can SHAZAM® the media to weed out pirate postings for the media (e.g., this can be used with movies as movies have a soundtrack that can be identified by SHAZAM®).

The aforementioned systems (e.g., the signature component 120, the source component 130, the device 140, etc.), architectures, environments, and the like have been described with respect to interaction between several components and/or elements. It should be appreciated that such components, devices, and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein for the sake of brevity, but known by those of skill in the art.

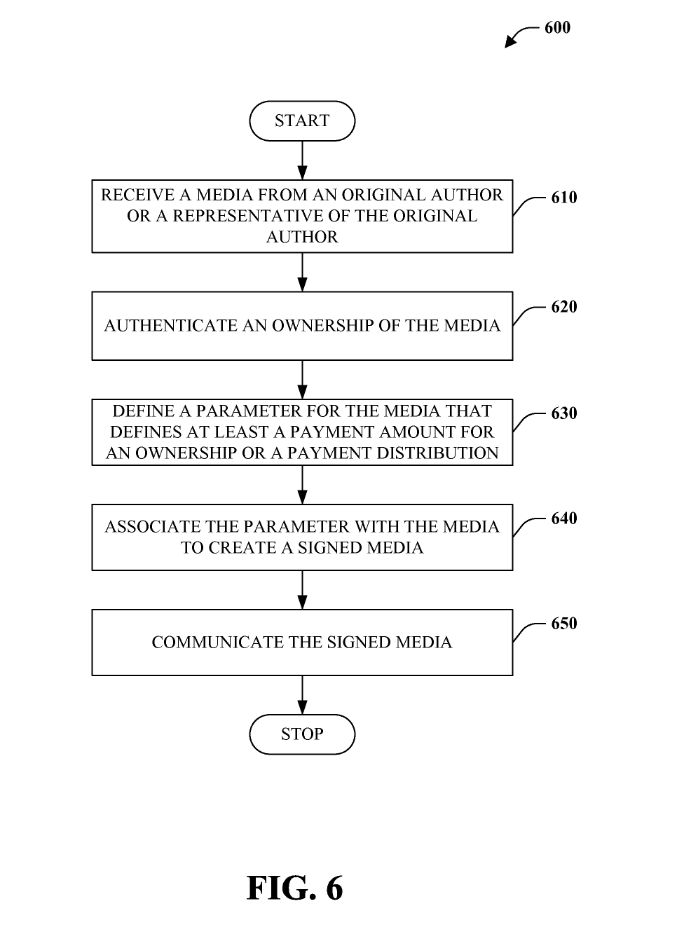

In view of the exemplary devices and elements described supra, methodologies that may be implemented in accordance with the disclosed subject matter will be better appreciated with reference to the flow charts of FIGS. 6-8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

FIG. 6 illustrates a flow chart of a method 600 for generating a signed media that includes parameters that define use thereof. At reference numeral 610, a media from an original author or a representative of the original author can be received. For example, a user can utilize a device to upload the media in an electronic format and then transmit or communicate the media. As discussed above, the media can be received, transmitted to, or communicated to, at least one of the signature component 120. In general, the media is received by at least one of a computer, a server, a component, a website, a cloud-based environment, and the like.

At reference numeral 620, an ownership of the media can be authenticated. For instance, the media can be registered with the U.S. Copyright Office or the foreign equivalent for copyright protection outside the U.S. In such instance, the copyright information can be validated. The validation can include electronic confirmation of a serial number, a receipt of filing, among others. Moreover, when a media is received, the sender of such media can be authenticated to ensure the sender is at least one of the following: a rightful owner of the copyright for the media, a representative of the owner, an original author, an agent of the media owner, a legal representative of the author of the media, among others. Thus, the authentication can determine whether the media is copyrighted and/or whether the media is submitted by an authorized source (e.g., agent, owner, author, and the like).

At reference numeral 630, a parameter for the media can be defined that defines at least a payment amount for an ownership or a payment distribution. By way of example and not limitation, the payment amount for an ownership of the media can be a download of an electronic copy of the media. In an example, the payment amount can vary based on a quality of the media, wherein a quality of video can be a video mode (e.g., 480i, 480p, 720i, 720p, 1080i, 1080p, among others), a quality of an image can be a pixel amount, and a quality of audio can be a sample rate. In another example, the payment amount can vary based on a number of electronic copies purchased. Thus, a user can purchase the media at a first price for one (1) electronic copy and a second user can purchase the media at a second price for two (2) electronic copies. And third user can choose “add to my playlist” at 30% of purchase price where seven additional streams (e.g., the additional streams can be paid for) would convert media to ownership. This option would require one central media delivery bank that would monitor number of streams by specific user. Cellular phone number would be the best identification of the user.

In an embodiment, the payment distribution can define how the payment amount is divided to whom. By way of example and not limitation, the payment distribution can include a percentage of the payment amount for at least one of the following: an owner of the media, an author of the media, an owner of the copyright for the media, a legal representative of the author, a legal representative of the owner, an agent of the author, an agent of the owner, a source that distributed the media, a website that advertised the media, a cellular service provider, an Internet Service Provider (ISP), a Wi-Fi host, among others. For example, the parameter can include a payment distribution in which a video sharing website can receive a percentage of a payment amount for a media when the media is purchased from the video sharing website. Following the example, the payment distribution can further define a percentage of the payment amount for an owner or holder of the copyright for the media.

At reference numeral 640, the parameter can be associated with the media to create a signed media. In an embodiment, the parameter can be associated with the media by including a portion of data within the electronic version of the media. In another embodiment, the parameter can be associated with the media by including a portion of data within the electronic version of the media by use of a frequency encoding. For instance, the frequency encoding can be included with the electronic format of the media such that when the media is executed (e.g., played, heard, viewed, etc.) the frequency used is unheard by a human ear. Yet, the frequency used to encode can be decoded by a device to identify the parameter(s). This frequency encoding and decoding can be referred to as audio watermark technology. It is to be appreciated that the disclosed innovation can utilize any suitable audio watermark technology.

At reference numeral 650, the signed media can be communicated. The signed media can be communicated in electronic format via, for instance, a wired connection, a wireless transmission (e.g., Radio Frequency Identification (RFID), Near-Field Communication (NFC), Wi-Fi, and the like), or a combination thereof

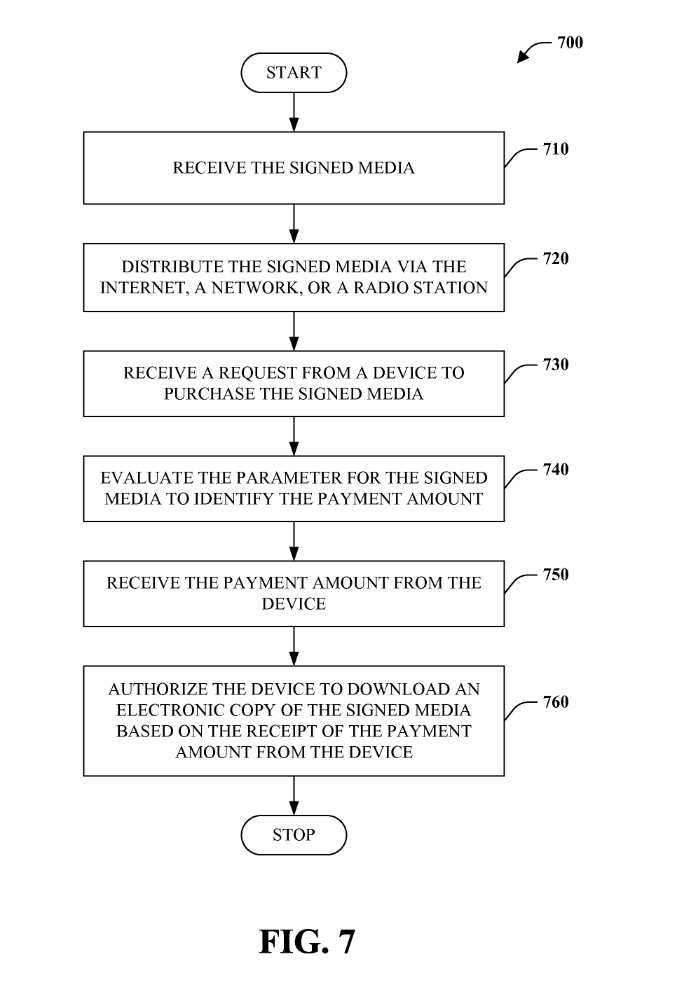

FIG. 7 illustrates a flow chart of a method 700 for distributing a payment amount for media based upon a portion of data included in signed media. At reference numeral 710, the signed media can be received. In an embodiment, the signed media can be received by the source component 130, the device 140, among others. At reference numeral 720, the signed media can be distributed via the Internet, a network, or a radio station. By way of example and not limitation, the distribution can be via a wired connection, a wireless connection, and/or a combination thereof.

At reference numeral 730, a request can be received from a device to purchase the signed media. For instance, the request can be received from the device in response to receipt and use of the signed media from the distribution source (e.g., the Internet, the network, the radio station, a television station, among others). At reference numeral 740, the parameter for the signed media can be evaluated to identify a payment amount. The payment amount is an amount that is to be paid for an electronic copy of the media for personal use on the device. By way of example and not limitation, the payment amount can be a flat-fee for unlimited use (e.g., duration of time, number of uses, etc.), a fee for a limited use (e.g., duration of time, number of uses, etc.), among others. In another example, the payment amount can include an amount that is to be paid for an electronic copy of the media for a commercial use. In another example, the payment amount can be an amount that is to be paid for an electronic copy of the media for use (e.g., commercial, personal, a combination thereof) for more than one device. In another example payment will cover initial stream and addition to the playlist few additional payments for consecutive streams will allow for full ownership.

At reference numeral 750, the payment amount can be received from the device. The payment amount can be communicated by, for example, an electronic funds transfer (EFT), a credit card payment over the Internet, a PAYPAL® payment, a website that allows web purchasing, a virtual wallet, a payment from a banking website, or billing to cellular phone bill account among others. It is to be appreciated that any suitable funds (e.g., credit, U.S. currency, electronic currency, open source peer-to-peer digital currency, check, among others), type of transfer of funds (e.g., wireless transfer, electronic transfers, among others) can be utilized with the subject innovation.

At reference numeral 760, the device can be authorized to download an electronic copy of the signed media based on the receipt of the payment amount from the device. In other words, the device can receive the electronic copy of the signed media upon confirmation of the payment amount. This electronic copy of the signed media affords a licensed version of the media based on the defined use within the parameter(s).

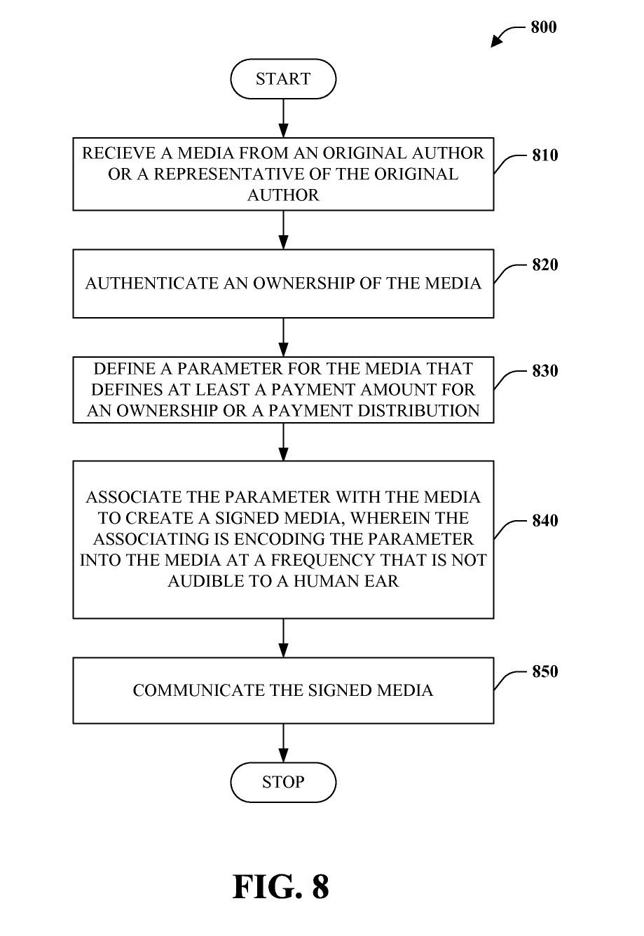

FIG. 8 illustrates a flow chart of a method 800 for utilizing a frequency to encode a parameter for the media. In general, the method 800 utilizes an audio watermark to incorporate a portion of data with the media to create a signed media. The signed media and, in particular, the portion of data can define at least one of a payment amount, a payment distribution, and/or a source that is allowed to distribute the signed media. At reference numeral 810, a media from an original author or a representative of the original author can be received. In another embodiment, the media can be received from an owner of the media or a U.S. copyright owner (or foreign country copyright owner) of the media. For instance, an original author of the media can transfer or sell his or her U.S. copyright to an entity and that entity can be the copyright owner. At reference numeral 820, an ownership of the media can be authenticated. At reference numeral 830, a parameter for the media can be defined that provides or defines at least a payment amount for an ownership or a payment distribution. It is to be appreciated that the ownership upon paying of the payment amount is in accordance with the electronic copy of the media. In other words, the payment amount is a sale that invokes the first-sale doctrine in the United States of America or a foreign country equivalent to the first-sale doctrine.

At reference numeral 840, the parameter can be associated with the media to create a signed media, wherein the associating of the parameter is an encoding of the parameter into the media at a frequency that is not audible to a human ear. For example, this encoding is also referred to as an audio watermark. The audio watermark can be detected by a device receiving a particular range of frequencies, whereas a human ear is not capable of hearing such particular range of frequencies. There are existing methods of watermarking that are inside of human hearing frequency transferable thru speakers and microphones. In other words, the use of audio watermark allows encoding of data (e.g., a portion of data that includes a parameter(s)) into the media to create signed media. It is to be appreciated that any suitable audio watermark technique can be used with the subject innovation.

At reference numeral 850, the signed media can be communicated. The distribution of the signed media allows one or more devices (on behalf of user(s)) to discover the signed media and, in turn, possibly purchase the signed media. The signed media can be received or a request for purchase of the signed media can be received.

Further, the method 800 can include decoding the signed media to identify one or more parameters that define at least one of a payment amount, a payment distribution, a source that distributed the signed media to the requestor (e.g., device that requests the purchase or accessed the signed media), a use permission (e.g., restricted use, unrestricted use, etc.). It is to be appreciated that the encoding and/or decoding of the media and the signed media respectively can be performed by at least one of a third-party component, a component, among others. Based on the identifying of the parameter(s), the method 800 can further include receiving the payment amount and communicating the signed media based on the received payment amount.

In an embodiment, the method can further include transferring the payment amount based on the payment distribution for the signed media. In an embodiment, the payment distribution includes distributing a portion of the payment amount to at least one of the original author, the representative of the original author, a music label that owns the media, a movie studio that owns the media, a source that hosts the signed media, or the radio station. In an embodiment, the method can further include utilizing the device to capture a portion of the signed media in at least one of an audible form or a picture form identifying the parameter for the signed media based on the captured portion.

In an embodiment, the associating the parameter with the media to create the signed media further includes encoding the parameter into the media at a frequency that is not audible to a human ear to associated the parameter with the media. In the embodiment, the method can further include utilizing the device to capture a portion of the signed media output from a second device, wherein the second device includes at least one of a speaker or a display. In the embodiment, the method can further include decoding the parameter at the frequency to identify the parameter for the signed media.

In an embodiment, a method is provided that includes at least the steps of: distributing a signed media via the Internet, a network, or a radio station; displaying a portion of data on a display in which the portion of data is associated with the signed media; playing the signed media; initiating a request from a device based on the displayed portion of data, wherein the request is communicated from the device to at least one of purchase the signed media or access the signed media; evaluating the parameter for the signed media to identify the payment amount; transmitting a payment amount from the device, wherein the payment amount is defined by a parameter within the signed media; and accessing an electronic copy of the signed media with the device based on the payment transmitted from the device.

In an embodiment, the subject innovation can include security techniques to provide secured communications with a transmission of a request and/or receipt of an access to a signed media. For instance, cryptology techniques in wired and/or wireless communication can be utilized such as, but not limited to, key-based techniques (e.g., public key, private key, random generated key, among others), access codes, RSA encryption, among others. In general, any suitable encryption and/or decryption can be used for at least one of the request and/or the access to the signed media. For instance, a request can be encrypted and received by a source (e.g., source that distributed the signed media), wherein the source decrypts the request. The response to the request (e.g., the communication of the signed media and/or access to the signed media) can further be encrypted and communicated to the requestor (e.g., user via a device for instance), wherein such request decrypts the response. It is to be appreciated that security techniques to ensure secure data communications between the request for a signed media and receipt for the signed media can be included within the scope of the subject innovation.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

Specific embodiments of an innovation are disclosed herein. One of ordinary skill in the art will readily recognize that the innovation may have other applications in other environments. In fact, many embodiments and implementations are possible. The following claims are in no way intended to limit the scope of the subject innovation to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein but generally known by those of skill in the art.

Although the subject innovation has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (e.g., components, devices, etc.), the terms (including a reference to a “means”) used to describe such elements are intended to correspond, unless otherwise indicated, to any element which performs the specified function of the described element (e.g., that is functionally equivalent), even though not structurally equivalent to the disclosed structure which performs the function in the herein illustrated exemplary embodiment or embodiments of the innovation. In addition, while a particular feature of the innovation may have been described above with respect to only one or more of several illustrated embodiments, such feature may be combined with one or more other features of the other embodiments, as may be desired and advantageous for any given or particular application. Although certain embodiments have been shown and described, it is understood that equivalents and modifications falling within the scope of the appended claims will occur to others who are skilled in the art upon the reading and understanding of this specification.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, any use of the terms “first,” “second,” etc., do not denote any order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not different from the literal language of the claims, or if they include equivalent structural elements with insubstantial differences from the literal language of the claims.

What is claimed is:

1. A system, comprising:
a first component that is configured to incorporate a portion of data to a media to create a signed media, wherein the portion of data includes a parameter;
a second component that is configured to provide a device a restricted access to the signed media, wherein the restricted access of the signed media to the device is defined by the parameter;
the device communicates a request to at least the first component or the second component for an unrestricted access to the signed media; and
at least the first component or the second component provide the device the unrestricted access to the signed media based on the parameter.

2. The system of claim 1, the parameter defines a payment amount that is to be received from the device to provide the device with the unrestricted access to the signed media.

3. The system of claim 2, the parameter defines a payment distribution for the payment amount between at least one of an owner of the media or a host of the second component.

4. The system of claim 2, the parameter defines a payment distribution for the payment amount between at least one of an owner of the media or a host of the first component.

5. The system of claim 1, the restricted access is at least one of a pre-defined amount of time for a preview of the signed media or a pre-defined number of uses for the signed media.

6. The system of claim 1, the media is at least one of a portion of audio in an electronic format or a portion of video in an electronic format.

7. The system of claim 1, the unrestricted access is at least one of a full duration of time for use of the signed media, an unlimited number of uses for the signed media, or a right to store an electronic version of the signed media on at least the device.

8. The system of claim 1, the second component is at least one of a website, a server, a social network, a cloud-based network, a hard drive, a computer, or a peer-to-peer network.

9. The system of claim 1, further comprising a third component that is configured to authorize an ownership of the media.

10. The system of claim 1, further comprising a fourth component that is configured to receive a request via at least one of the device or the second component, wherein the request is an electronic transmission from the device in a format.

11. The system of claim 10, the format is at least one of a transmission of data packets via the Internet, a short message service (SMS) message, a text message, an email, a capture of a Quick Response (QR) code, an input from a keyboard, or an input from the device.

12. The system of claim 1, further comprising a fifth component that is configured to dynamically adjust the parameter based on at least one of a number of restricted access, a number of unrestricted access, or a number of the requests.

13. The system of claim 1, the second component is at least one of a video sharing website, an audio sharing website, a text sharing website, a streaming video sharing website, or a streaming audio sharing website.

14. A method comprising:
receiving a media from an original author or a representative of the original author;
authenticating an ownership of the media;
defining a parameter for the media that defines at least a payment amount for an ownership or a payment distribution;
associating the parameter with the media to create a signed media; and
communicating the signed media.

15. The method of claim 14, further comprising:
receiving the signed media;
distributing the signed media via the Internet, a network, or a radio station;
receiving a request from a device to at least one of purchase the signed media or access the signed media;
evaluating the parameter for the signed media to identify the payment amount;
receiving the payment amount from the device; and
authorizing the device to download an electronic copy of the signed media based on the receipt of the payment amount from the device.

16. The method of claim 15, further comprising transferring the payment amount based on the payment distribution for the signed media.

17. The method of claim 16, the payment distribution includes distributing a portion of the payment amount to at least one of the original author, the representative of the original author, a music label that owns the media, a movie studio that owns the media, a source that hosts the signed media, or the radio station.

18. The method of claim 15, further comprising:
utilizing the device to capture a portion of the signed media in at least one of an audible form or a picture form; and
identifying the parameter for the signed media based on the captured portion.

19. The method of claim 15, further comprising:
wherein the associating the parameter with the media to create the signed media further comprises encoding the parameter into the media at a frequency that is not audible to a human ear to associated the parameter with the media;
utilizing the device to capture a portion of the signed media output from a second device, wherein the second device includes at least one of a speaker or a display; and
decoding the parameter at the frequency to identify the parameter for the signed media.

20. A system, comprising:
means for incorporating a portion of data to a media to create a signed media, wherein the portion of data includes a payment amount and a distribution of the payment amount;
a media source that is configured to distribute the signed media via at least one of radio waves or the Internet;
means for capturing a portion of the signed media in at least one of an audio form or a picture form from the media source;
means for identifying the payment amount for the signed media based on the captured portion of the signed media;
means for receiving the payment amount; and
means for disturbing the payment amount for the signed media based on the distribution.

21. A method, comprising:
distributing a signed media via the Internet, a network, or a radio station;
displaying a portion of data on a display in which the portion of data is associated with the signed media;
playing the signed media;
initiating a request from a device based on the displayed portion of data, wherein the request is communicated from the device to at least one of purchase the signed media or access the signed media;
evaluating the parameter for the signed media to identify the payment amount;
transmitting a payment amount from the device, wherein the payment amount is defined by a parameter within the signed media; and
accessing an electronic copy of the signed media with the device based on the payment transmitted from the device.
